(19) United States
(12) Patent Application Publication
(10) Pub. No.: US 2010/0182456 A1
(43) Pub. Date: Jul. 22, 2010

(54) IRIS IMAGE STORING METHOD AND AN IRIS IMAGE RESTORED METHOD

(76) Inventors: Dae Hoon Kim, Seoul (KR); Hyeong In Choi, Seoul (KR); Seung Min Paik, Seoul (KR); Jung Kyo Sohn, Seoul (KR); Yang Hyeong Park, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/676,355

(22) PCT Filed: Sep. 5, 2008
(86) PCT No.: PCT/KR2008/005253

§ 371 Date: Mar. 3, 2010

(30) Foreign Application Priority Data
Sep. 7, 2007 (KR) 10-2007-0090917

(51) Int. Cl. H04N 5/76; G06K 9/54; G06K 9/36

(52) U.S. Cl. 348/231.6; 382/305; 382/244; 348/E07.085

(57) ABSTRACT

The present invention relates to a method of storing and restoring an iris image, the method comprising the steps of: acquiring an original image I^{ori} including an iris portion from a camera; acquiring a first image I^{extract1} configured with an area removed of portions outside of an outer circle and images included within an inner circle (hereinafter, referred to as an ‘iris enveloping annulus’) in order to extract an iris image to be stored from the original image; acquiring a second image I^{extract2} removed of an occlusion portion of the iris, such as a pupil, a white of an eye, an eyelash, an eyelid, hairs, and the like, from the first image; converting the second image I^{extract2} removed of the occlusion portion into a polar image I^{polar} of a polar coordinate system, or acquiring a compressed image I^{comp} compressing the converted polar image; storing the compressed image I^{comp} in memory, together with restoration information H, as storage image data I^{store}; and acquiring a restored image I^{restored} using a restoration algorithm from the storage data when recognizing the iris, thereby reducing memory capacity for storing the image, and improving processing speed when recognizing an iris.

### TECHNICAL FIELD

The present invention relates to a method of storing and restoring an iris images, the method comprising the steps of

acquiring an original image I^{ori} including an iris portion from a camera or the like; acquiring a first image I^{extract1} removed of portions outside of an outer circle and images included within an inner circle in order to extract an iris image from the original image; converting the first image I^{extract1} included between the outer and inner circles into a polar image I^{polar} of a polar coordinate system, or acquiring a second image I^{extract2} removed of an occlusion portion of an iris from a portion where the first image I^{extract1} included between the outer and inner circles is acquired, and converting the second image I^{extract2} where the occlusion portion is processed into a polar image I^{polar} of the polar coordinate system; acquiring a compressed image I^{comp} from the converted polar image I^{polar}; storing the compressed image, together with information H for restoring the compressed image I^{comp}, in memory as storage data I^{store}; and acquiring a restored image from the storage data I^{store} stored in the memory using a restoration algorithm when recognizing the iris, so that the method of storing and restoring an iris image, which is different in each iris recognition system, is unified and standardized as a common specification, and thus inefficiency and cost of memory storage accompanied by storing and restoring the iris image can be reduced, and processing speed is improved in all iris recognition systems.

### BACKGROUND ART

In general, an image of an eye acquired from a camera includes a pupil, a white of the eye, an eyelash, an eyelid, and hairs all together in addition to an iris portion. However, since an iris recognition algorithm compares an iris using only an iris image that remains after removing the portions unrelated to the iris image, these can be regarded as unnecessary portions.

The method used for storing an iris image and using the iris image when recognizing an iris is largely divided into two types. In the first method, the entire original image data including unnecessary portions such as a pupil, a white of an eye, an eyelash, an eyelid, hairs, and the like is stored in memory, and only the iris image extracted from the image including unnecessary portions such as a pupil, a white of an eye, an eyelash, an eyelid, hairs, and the like stored in the memory is used when iris recognition is executed. In the second method, before storing iris information in the memory, an “iris boundary” is exactly found out off-line, and only “pure iris image portion” is extracted and stored. Then, when recognizing an iris, the iris is promptly compared and recognized using the “pure iris image portion” without a separate iris image extraction process such as finding an iris boundary and the like.

According to the former method, there is not a special problem when original image data is stored in a device having a large memory capacity for storing an original image. However, when the original image should be stored in a recognition apparatus having a small storage capacity, for example, when the original image needs to be stored in a smart card or the like having a storage space of about 4 Kbytes, a memory shortage problem occurs, and processing speed can be slowed down to some extent in the step of comparing the iris for recognition. Although the latter case may be regarded as the most ideal method, generally, since it is ambiguous in that to which portion of an original eye image is regarded as the “pure iris portion” the “pure iris portion” may be different depending on an extraction algorithm. Furthermore, when only an algorithm for finding a boundary of a specific fixed iris is applied, an iris recognition rate may be lowered depending on an image. Accordingly, it is desirable that an iris boundary is searched for at a time point when an iris is recognized in order to make a room for selecting and applying an algorithm for searching for an appropriate boundary of an iris image depending on a used image, and in this case, memory space can be greatly saved, and processing speed of the step of comparing and recognizing an iris can be enhanced.

Since the former method is used to store an original image in the prior art, there is a problem in that a large memory space is occupied when the original image is stored in memory, and a large amount of processing time is required when an iris is recognized since an iris image should be extracted and used from the original image when the iris image is compared.

### DISCLOSURE OF INVENTION

### Technical Problem

Accordingly, the present invention has been made in order to solve the above problems, and it is an object of the invention to provide a method of storing and restoring an iris image, in which an iris enveloping annulus portion is extracted, compressed, and stored in memory before unnecessary images, such as a pupil, a white of an eye, an eyelash, an eyelid, hairs, and the like included in the original image, are stored in the memory, and only the iris image information stored in the memory is directly used when an iris is recognized, without an additional iris image extraction process, thereby reducing the amount of data stored in a smart card or general memory and enhancing processing speed in the step of comparing and recognizing the iris.

Another object of the invention is to unify and standardize the method of storing and restoring an iris image, which is different in each iris recognition system, as a common specification in order to reduce inefficiency and cost of memory space accompanied by storing and restoring the iris image and improve processing speed when recognizing the iris in all iris recognition systems.

### Technical Solution

In order to accomplish the above objects of the invention, according to one aspect of the invention, there is provided a method of storing and restoring an iris image, the method comprising the steps of: acquiring an original image I^{ori} including an iris portion from a camera; acquiring a first image I^{extract 1} configured with an area removed of portions outside of an outer circle and images included within an inner circle (hereinafter, referred to as an ‘iris enveloping annulus’) in order to extract an iris image to be stored from the original image; acquiring a second image I^{extract2} removed of an occlusion portion of the iris, such as a pupil, a white of an eye, an eyelash, an eyelid, hairs, and the like, from the first image; converting the second image I^{extract2} removed of the occlusion portion into a polar image I^{polar} of a polar coordinate system, or acquiring a compressed image I^{comp} compressing the converted polar image; storing the compressed image I^{comp} in memory, together with restoration information H, as storage image data I^{store}; and acquiring a restored image I^{restored} using a restoration algorithm from the storage data when recognizing the iris, thereby reducing memory capacity for storing the image, and improving processing speed when recognizing an iris.

According to another aspect of the invention, there is provided a method of storing and restoring an iris image, the method comprising the steps of: acquiring an original imageincluding an iris portion; acquiring a first imageremoved of portions outside of an outer circle and images included within an inner circle in order to extract an iris image from the original image; converting the first image included in an iris enveloping annulus portion into a polar image of a polar coordinate system, or acquiring a compressed image compressed from the converted polar image; storing the compressed image in memory, together with restoration information, as final storage data; and restoring and using the first image restored using a restoration algorithm from the final storage data when recognizing an iris, thereby reducing storage capacity of the memory for storing an image, and improving processing speed when recognizing an iris.

According to another aspect of the invention, the method of storing and restoring an iris image, which is different in each iris recognition system, is unified and standardized as a common specification, in which an image of an iris enveloping annulus portion is used as is, or an iris image removed of occlusion portions, such as a pupil, a white of an eye, an eyelash, an eyelid, hairs, and the like, from the image of an iris enveloping annulus portion is used, so that the iris image is stored in memory and the iris image stored in the memory is restored in a standardized method according to the present invention in all iris recognition systems. Therefore, it is possible to implement a method of storing and restoring an iris image, which can store the iris image in a smart card or the like having a small storage capacity, reduce inefficiency and cost of memory or the like for storing the image, and enhance processing speed when an iris is recognized.

### Advantageous Effects

The present invention is effective in that an iris image is compressed and stored in a method of storing and restoring an iris image, using an image of an iris enveloping annulus as is or an iris image removed of occlusion portions, such as a pupil, a white of an eye, an eyelash, an eyelid, hairs, and the like, from the image of the iris enveloping annulus, and thus iris information can be easily stored in a smart card or the like having a small storage capacity. In addition, processing speed can be greatly improved since targets to be extracted and compared can be reduced when recognizing an iris.

Furthermore, when an iris image removed of occlusion portions, such as a pupil, a white of an eye, an eyelash, an eyelid, hairs, and the like, from the image of an iris enveloping annulus is used in the method of storing and restoring an iris image, the iris enveloping annulus is extracted, compressed, and stored in memory before unnecessary images are stored in the memory, and only the iris image information stored in the memory is used when an iris is recognized, and thus the present invention is effective in that memory space is greatly saved, and processing speed is enhanced by directly using the iris image information without an additional iris image extraction process for searching for an iris boundary and the like.

The present invention is effective in that the method of storing and restoring an iris image, which is different in each iris recognition system, is unified and standardized as a common specification in the method described above, and thus inefficiency and cost of memory and the like accompanied by storing and restoring an iris image can be reduced, and processing speed is improved in all iris recognition systems.

### BRIEF DESCRIPTION OF THE DRAWINGS

FIG. 1 is a view showing the configuration of storing and restoring an image of an iris enveloping annulus portion as is according to the present invention.

FIG. 2 is a view showing the configuration of storing and restoring an iris image, in which occlusion portions such as the a pupil, a white of an eye, an eyelash, hairs, and the like are processed from an image of an iris enveloping annulus according to the present invention.

FIG. 3 is a flowchart according to FIG. 1.

FIG. 4 is a flowchart according to FIG. 2.

FIG. 5 is a view showing an outer circle and an inner circle expressing an iris enveloping annulus portion according to the present invention.

FIG. 6 is a view showing information included when an iris image is stored according to the present invention.

FIG. 7 is a view showing a conversion relation between a polar coordinate system and a Descartes coordinate system.

### BEST MODE FOR CARRYING OUT THE INVENTION

The mode of the present invention related to a method of storing and restoring an iris image, comprising the steps of acquiring an original image I^{ori} including an iris portion from a variety of external cameras or apparatuses capable of obtaining an iris image in the embodiment described above, acquiring a first image I^{extract1}, which is an image included in the iris enveloping annulus and extracted, from the original image, converting the first image included in the iris enveloping annulus into a polar image I^{polar} of a polar coordinate system or acquiring a compressed image I^{comp} compressing the converted polar image in order to reduce the amount of image data stored in memory, storing the compressed image in the memory or a database together with restoration information H as final storage image data I^{store}, and acquiring a restored image I^{restored} from the final storage image data stored in the memory and a database using a restoration algorithm when an iris is recognized and compared.

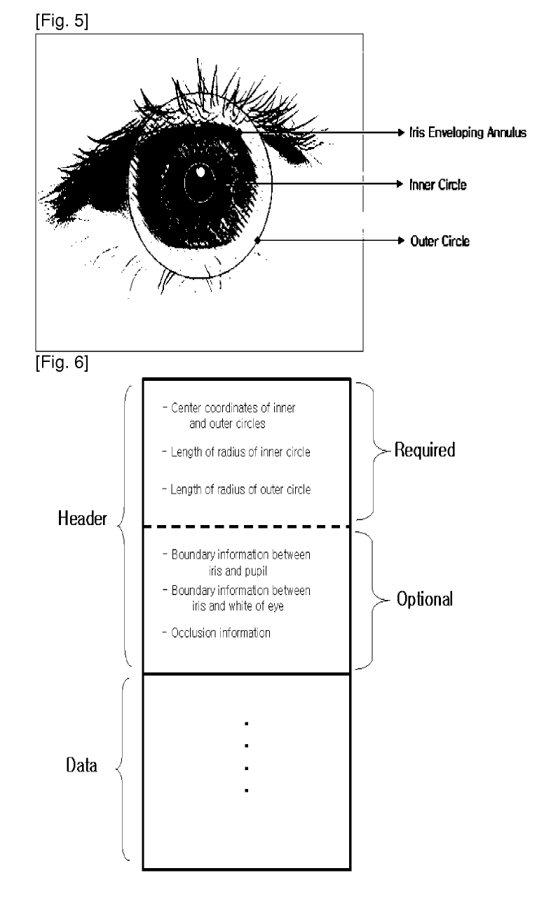

FIG. 5 is a view showing an outer circle and an inner circle expressing an iris enveloping annulus portion according to the present invention. In FIG. 5, although the outer circle is preferably formed as a circle having a center corresponding to those of the inner circle and the iris image, while including the entire iris portion of an original image, the outer circle can be formed as an oval. Although it is most preferable that the inner circle is placed within a pupil where the iris image is not included among the original image and formed as a circle or an oval having a center corresponding to those of the outer circle and the iris image, it is sufficient that the iris enveloping annulus portion is a curved line that completely contains the iris portion, while having a shape that can be uniquely determined using a small number of parameters.

### MODE FOR THE INVENTION

The mode for carrying out the present invention is described based on the drawings.

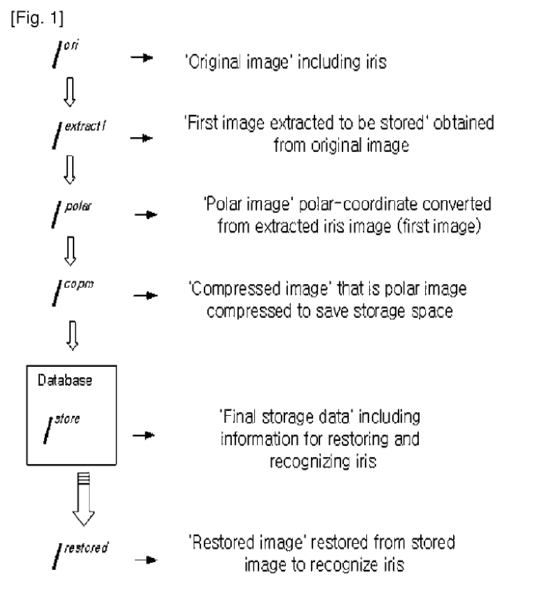

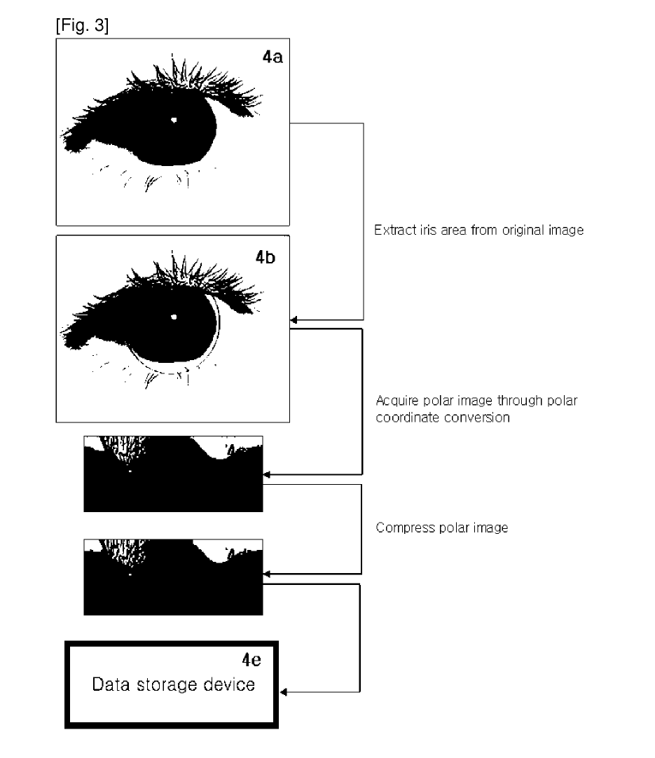

An embodiment according to the present invention is shown FIGS. 1 and 3. FIG. 1 is a flowchart illustrating a method of storing and restoring an image of an iris enveloping annulus portion as is according to the present invention, and FIG. 3 is a flowchart according to FIG. 1.

The configuration of the mode for carrying out the present invention is described in detail. The step of acquiring an original image is described. Acquisition of an original image is a step of acquiring an original image I^{ori} including an iris portion using various kinds of cameras and apparatuses capable of obtaining an iris image, and it is general that the step is necessarily performed for iris recognition.

Next is the step of extracting a first image I^{extract1}, which is an image included in the iris enveloping annulus portion among the original image I^{ori} acquired from a camera, in order to store an iris image used for iris recognition and comparison. Describing further specifically, an image portion that needs to be stored is extracted from the original image I^{ori} in order to occupy less storage space when storing an image in memory. To this end, the present invention performs the steps described below. First, an inner circle C^{inner} is drawn within the pupil that does not contain an iris image among the original image I^{ori} acquired from a camera. Next, an outer circle C^{outer}, which includes all portions of the iris among the same original image I^{ori} acquired from a camera and has a center that is the same as that the inner circle C^{inner}, is drawn. Here, the inner circle C^{inner} may be a degenerated circle. That is, it may be a point. The inner circle is completely included within the outer circle C^{outer}, and all image information on the iris portion among the original image acquired from a camera is included in an area between the two circles.

The area between the inner circle and the outer circle is referred to as the previously defined “iris enveloping annulus”. The image shown in the area becomes the first image I^{extract1} extracted to be stored. Here, although the centers of the two circles preferably correspond to the center of a curved line or a circle that represents the boundary of the iris, they do not need to necessarily correspond to the center of the curved line or circle representing the boundary of the iris, and this can be configured to be processed by an iris image processing program.

The shape of the two border lines that determines the shape of the extracted first image does not necessarily need to be a circle. It is sufficient that the two border lines are a curved line that completely includes the iris portion, while having a shape that can be uniquely determined with one or more parameter values.

For example, when the curved lines located inside and outside of the first image are formed as an oval, only the center and lengths of the major and minor axes are needed. As a result, it is sufficient that the shape of the iris enveloping annulus I^{extract1} extracted to be stored can be completely described with a few parameters. In the embodiment, it will be described assuming that both of the curved lines located inside and outside of the first image, which is the iris enveloping annulus portion, are circles and they have the same center. It makes no difference although curved lines are used instead of circles or the centers of the inner and outer circles of the first image, which is the iris enveloping annulus, are different from each other. It is since that all of these can be processed by an iris image processing program although processing procedures thereof can be complex.

If it is assumed that the common center of the inner and outer circles is 0 and radiuses of the two circles are respectively r^{inner} and r^{outer}, the two radiuses should satisfy mathematical expression (1) shown below.

0=r^{inner}=r^{outer} (1)

The area between the inner and outer circles C^{inner} and C^{outer} becomes the previously defined iris enveloping annulus or an iris enveloping disk, and this area is extracted according to an embodiment of the present invention and becomes the first image to be stored in the memory.

If the first image of the previously extracted iris enveloping annulus portion is converted into a polar coordinate system, it becomes a polar image of a rectangular shape.

If it is assumed that both of the curved lines C^{inner} and C^{outer} are circles, conversion to a rectangular image is natural in a polar coordinate system since they are form as an annulus or a disk. If a polar coordinate conversion function is defined as f, a general mathematical expression becomes f⁻¹(r,θ=(r cos θ, r sin θ).

If it is assumed that an area that expresses the first image is Ω and a function for converting the first image into a polar coordinate system is f, a resulting rectangular area f(Ω) can be defined to as R. On the other hand, the width (an angle direction) and the height (a radius direction) of the polar image can be varied depending on the size of an original image or can be configured regardless of the size of the original image by standardizing the size of a rectangular image to be converted.

FIG. 7 is a view showing conversion between a Descartes coordinate system and a polar coordinate system, which is a technique generally used in an iris recognition method. In relation to the technique, it is a technique used and publicized by Korean Laid-opened Patent Gazette No. 10-2006-0081380 applied by the applicant and inventor of the present invention and allowed, and Korean Laid-opened Patent Gazette No. 10-2007-0088982 applied by the applicant and inventor of the present invention and opened, details of which will be omitted in the specification.

Next, the step of acquiring an image compressed from a polar image is described in detail. One of major constitutional elements of the present invention is reducing an image size in storing an iris image, while completely including the portion of the iris in the original image, so that the size of a file to be stored is greatly reduced to be easily stored in a smart card or the like having a small storage capacity, or to save memory space when the image is stored in general memory. Accordingly, a polar image rendered according to the present invention is converted and stored as a compressed file. A general compression algorithm is used as an algorithm for compressing the polar image. If it is possible to convert the polar image into a file that can be restored and recognized when restoring the file, any algorithm can be used. For example, a lossless compression algorithm generally and frequently used in creating a .zip file, or a loss compression algorithm generally used in creating a jpeg or jpeg2000 file having a data loss can be used. If a target image file size is previously determined and an image file is compressed in a loss compression algorithm, the file can be compressed within the target image file size by adjusting quality parameters. I^{comp} denotes a compressed image compressing a polar image.

Next, the step of storing the compressed image I^{comp} compressing the polar image I^{polar}, together with restoration information H, as storage data that is finally stored in memory is described in detail.

The restoration information H includes information for restoring I^{extract1} from I^{polar}. The final storage data Iₛₜₒᵣₑ should include parameters for determining the shape of I^{extract1}. For example, if both of two curved lines that determine the shape of I^{extract1} are circles, it is sufficient to include information on the center coordinate and radius of each circle. That is, only the center coordinate and radiuses of the two circles C^{inner} and C^{outer} need to be included, and other than these, additional information that can support iris recognition can be selectively included. The additional information that can be selectively added includes one or more of information on the boundary between the iris and the pupil, information on the boundary between the iris and the white of the eye, and information on occlusion, and the like.

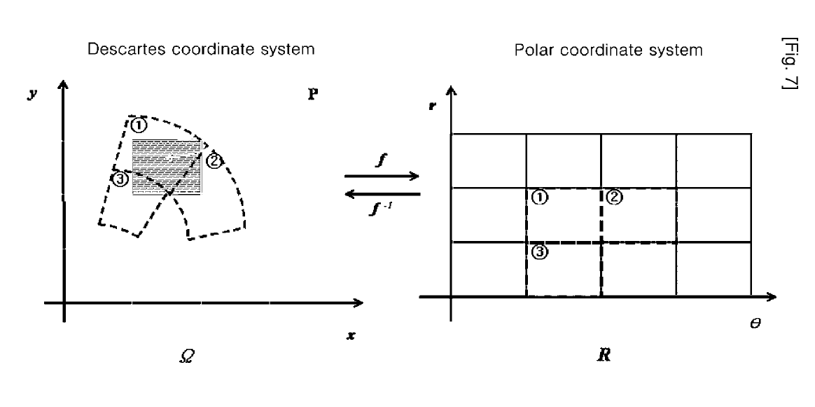

The final storage data I^{store}, including restoration information H in addition to a basic compressed image I^{comp} or the basic compressed image I^{comp} selectively added with additional information for iris recognition described above, is stored in a storage apparatus such as a smart card and/or memory. FIG. 6 is a view showing an example of a file format of the final storage data according to the present invention.

Next, the step of acquiring a restored image I_{restored} from I^{store} using a restoration algorithm when an iris is recognized is described in detail. It is the step of restoring an iris image from the final storage data stored in memory or a database on the memory. An annulus or disk shape (a kind of frame) of a first storage image is found out using the restoration information H, and an image data having the annulus or disk shape is restored by restoring the polar or compressed image and filling the frame with contents. The first image restored from the final storage data using the restoration algorithm is referred to as a ‘restored image’.

Depending on the type of algorithm applied when the compression is performed, the restored image I^{restored} may not be the same as the original first image extracted to be stored. The reasons are that, first, since there occurs a loss in the image information as described above when the loss compression algorithm is applied, an image having a quality level corresponding to that of the original image cannot be restored when it is decompressed, second, this phenomenon occurs since an image is a function defined on a definite number of pixels having an integer coordinate. Considering the second problem, the image is restored as shown in FIG. 7. In FIG. 7, in a view drawing a Descartes coordinate system, a value of the color or brightness of a shaded pixel P is assigned using values of colors or brightness of all pixels where an image according to f⁻¹ is overlapped with P (\textcircled{1}, \textcircled{2}, and \textcircled{3} of FIG. 7). For example, the area where an inverse image of the dotted areas in the left side figure is overlapped with P is taken as a weight, and a weighted average can be given. Other than this, there is a variety of methods.

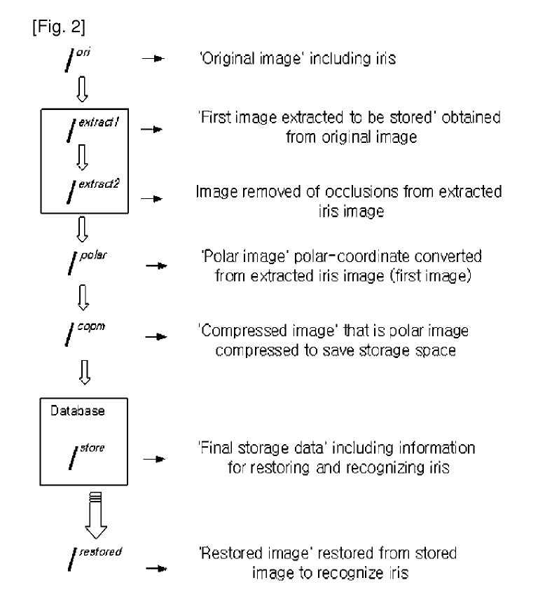

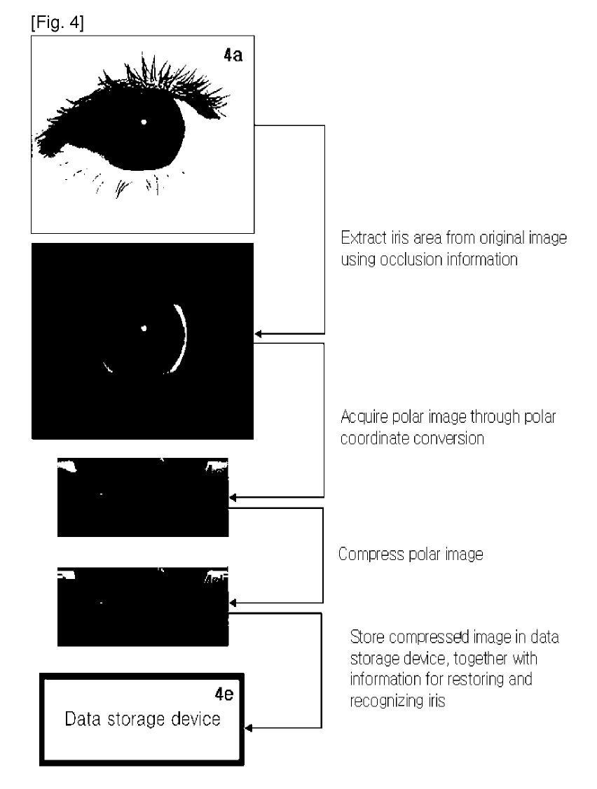

Still another embodiment according to the present invention is shown in FIGS. 2 and 4. FIG. 2 is a flowchart illustrating a method of storing and restoring an iris image, in which occlusion portions such as a pupil, a white of an eye, an eyelash, an eyelid, hairs, and the like are removed from an image of an iris enveloping annulus according to the present invention, and FIG. 4 is a view showing the flowchart according to FIG. 2 as a figure. The embodiment is related to a method of storing and restoring an iris image based on FIGS. 2 and 4. In the embodiment described above, the method of storing and restoring an iris image according to the present invention comprises the steps of acquiring an original image including an iris portion from a variety of external cameras or apparatuses capable of obtaining an iris image, acquiring a first image, which is an image included and extracted from the iris enveloping annulus, from the original image, converting the first image included in the iris enveloping annulus into a polar image of a polar coordinate system or acquiring a compressed image compressing the converted polar image using a compression algorithm in order to save storage space in memory, storing the compressed image in the memory or a database together with restoration information as final storage image data I^{store}, and acquiring a restored image from the final storage image data using a restoration algorithm when an iris is recognized. The step of acquiring a first image, which is an image included and extracted from the iris enveloping annulus, from the original image comprises the steps of acquiring a second image removed of various iris occlusion factors, such as a pupil, a white of an eye, an eyelash, an eyelid, hairs, and the like, from the first image before converting the image into a polar coordinate system in order to store the image and converting the second image removed of the occlusion portion into a polar image of a polar coordinate system. Therefore, memory space can be saved since the amount of compressed and stored information is smaller than that of the embodiment. In addition, since only the iris image information stored in the memory is used, the method is used to directly compare and recognize an iris without an additional iris image extraction process such as finding an iris boundary. Therefore, the speed of recognizing and processing an iris can be improved.

Other than the configuration according to the present invention described above, the others are the same as the mode of the embodiment described above (shown in FIGS. 1 and 3), and thus detailed description thereof will be omitted. The step of acquiring a second image removed of an iris occlusion image, including a pupil, a white of an eye, an eyelash, an eyelid, hairs, and the like, according to still another embodiment will be described in detail.

The step of acquiring a second image comprises the steps of acquiring an original image including an iris portion from a variety of external cameras or apparatuses capable of obtaining an iris image, acquiring a first image, which is an image included and extracted from the iris enveloping annulus, from the original image, and removing the portions occluding the iris portion, such as a pupil, a white of an eye, an eyelash, an eyelid, hairs, and the like, from the first image. Although the occlusion portions exist within the iris image, they are unnecessary in recognizing the iris and may negatively affect the recognition as well, and thus it is preferable to remove them in advance. One of the major objects of the present invention is to reduce a file size of an image to be stored in order to use a smart card or save memory space, and thus when the occlusion portions are removed, all the pixels belong to the occlusion portions are assigned with a value of the same color, e.g., white or block, which are shown in FIG. 4(b). It is to obtain a further higher compression ratio when an image is compressed into a final storage data described in the embodiment and minimize memory space of an iris image to be stored. An image removed of the occlusion portions in the method described above is referred to as a second image.

In an embodiment and another embodiment according to the present invention, it is preferable to compress and store an iris image when the iris image is stored in order to save memory space for storing the image. However, if the amount of image information included in an iris enveloping annulus is sufficiently small without being compressed, the processing speed and recognition ratio can be enhanced by storing the image in an uncompressed state.

### INDUSTRIAL APPLICABILITY

In the present invention, an iris image is compressed and stored using an image of an iris enveloping annulus portion or an iris image removed of occlusion portions, such as a pupil, a white of an eye, an eyelash, an eyelid, hairs, and the like, from the iris enveloping annulus portion. Therefore, since iris information can be easily stored in a smart card having a small memory capacity, and targets to be extracted and compared can be reduced when an iris is recognized, processing speed can be greatly improved, and thus the present invention is highly applicable to industry.

Although the present invention has been described with reference to several preferred embodiments, the description is illustrative of the invention and is not to be construed as limiting the invention. Various modifications and variations may occur to those skilled in the art, without departing from the scope of the invention as defined by the appended claims.

1. A method of storing an iris image in a smart card and memory, the method comprising:
acquiring an original image including an iris portion from a camera;
extracting a first image included in an iris enveloping annulus portion from the original image;
converting the extracted first image into a polar image of a polar coordinate system, or acquiring a compressed image compressing the polar image using a compression algorithm in order to reduce an amount of data'stored in the memory; and
storing information for restoring the polar image or the compressed image, together with the polar image or the compressed image, in a storage device as storage data.

2. A method of storing an iris image in a smart card and memory, the method comprising:
acquiring an original image including an iris portion from a camera;
extracting a first image included in an iris enveloping annulus portion from the original image;
converting the extracted first image into a polar image of a polar coordinate system, or acquiring a compressed image compressing the polar image using a compression algorithm in order to reduce an amount of data stored in the memory;
storing information for restoring the polar image or the compressed image, together with the polar image or the compressed image, in the memory or a database as storage data; and
acquiring a restored image from the storage data stored in the memory or the database in order to recognize and compare an iris using a restoration algorithm.

3. A method of storing an iris image in a smart card and memory, the method comprising:
acquiring an original image including an iris portion from camera;
extracting a first image included in an iris enveloping annulus portion from the original image;
acquiring a second image removed of an occlusion portion of an iris from the extracted first image;
converting the second image removed of the occlusion portion of the iris into a polar image of a polar coordinate system, or acquiring a compressed image compressing the polar image using a compression algorithm in order to reduce an amount of data stored in the memory; and
storing information for restoring the polar image or the compressed image, together with the polar image or the compressed image, in the memory or a database as storage data.

4. A method of storing an iris image in a smart card and memory, the method comprising:
acquiring an original image including an iris portion from a camera;
extracting a first image included in an iris enveloping annulus portion from the original image;
acquiring a second image removed of an occlusion portion of an iris from the extracted first image;
converting the second image removed of the occlusion portion of the iris into a polar image of a polar coordinate system, or acquiring a compressed image compressing the polar image using a compression algorithm in order to reduce an amount of data stored in the memory;
storing information for restoring the polar image or the compressed image, together with the polar image or the compressed image, in the memory or a database as storage data; and
acquiring a restored image from the storage data stored in the memory or database in order to recognize and compare the iris using a restoration algorithm.

5. The method according to claim 1, wherein an outer circle forming the iris enveloping annulus portion is formed as a circle or an oval including an entire iris portion among the original image and having a center corresponding to that of an inner circle, and the inner circle is placed within a pupil where the iris image is not included among the original image and formed as a circle or an oval having a center corresponding to that of the outer circle.

6. The method according to claim 2, wherein an outer circle forming the iris enveloping annulus portion is formed as a circle or an oval including an entire iris portion among the original image and having a center corresponding to that of an inner circle, and the inner circle is placed within a pupil where the iris image is not included among the original image and formed as a circle or an oval having a center corresponding to that of the outer circle.

7. The method according to claim 5, wherein if both of two curved lines determining a shape of the first image are circles, the storage data includes extracted iris image information and information on a center coordinate and a radius of each circle.

8. The method according to claim 7, wherein the storage data selects and further includes one or more of boundary information between the iris and the pupil, boundary information between the iris and the white of an eye, and occlusion information.

9. The method according to claim 6, wherein if both of two curved lines determining a shape of the first image are circles, the storage data includes extracted iris image information and information on a center coordinate and a radius of each circle.

10. The method according to claim 9, wherein the storage data selects and further includes
one or more of boundary information between the iris and the pupil, boundary information between the iris and the white of an eye, and occlusion information.

11. The method according to claim 3, wherein when the occlusion portion is removed, a value of the same color, e.g., either of white or block, is selected and assigned to all pixels belong to the occlusion portion.

12. The method according to claim 4, wherein when the occlusion portion is removed, a value of the same color, e.g., either of white or block, is selected and assigned to all pixels belong to the occlusion portion.

13. The method according to claim 5, wherein a lossless compression algorithm or a loss compression algorithm allowing a data loss is used as the algorithm for compressing the polar image considering memory capacity and loss of image information, and when a target image file size is previously determined and an image file is compressed in the loss compression algorithm, the file is compressed within the target image file size by adjusting quality parameters.

14. The method according to claim 6, wherein a lossless compression algorithm or a loss compression algorithm allowing a data loss is used as the algorithm for compressing the polar image considering memory capacity and loss of image information, and when a target image file size is previously determined and an image file is compressed in the loss compression algorithm, the file is compressed within the target image file size by adjusting quality parameters.
